(19) United States
(12) Patent Application Publication
(10) Pub. No.: US 2016/0144760 A1
(43) Pub. Date: May 26, 2016

(54) LIFTING AND STOWAGE SYSTEM

(71) Applicant: Peter Anthony VAN OYEN, Shelby Township, MI (US)

(72) Inventor: Peter Anthony VAN OYEN, Shelby Township, MI (US)

(21) Appl. No.: 14/551,449

(22) Filed: Nov. 24, 2014

(51) Int. Cl. B60P 1/64; B60P 3/06

(52) U.S. Cl. CPC B60P 1/6418; B60P 3/06

(57) ABSTRACT

A lift assist is provided for lifting at least one object to and from any suitably-sized container for stowage, transportation or usage. Say the object is a foldable wheelchair. The lift assist may include a water-proof body sheet folded to form a pocket for receiving the folded wheelchair. The pocket may be detachably closed to protectively cover the wheelchair so as not the damage or otherwise expose it to the container or vise versa. The list assist includes a lift assembly which operably engages a plurality of lift supports disposed along and inward from at least one lift edge of the body sheet. The lift assembly may include a pulley and cord and attachments for removably attaching near the container so that a user may manipulate the cord to pull and lift the protected wheelchair into the container.

### BACKGROUND OF THE INVENTION

The present invention relates to wheelchair lifts and, more particularly, to a wheelchair lifting and stowage system.

The need to load bulky heavy objects, such as wheelchairs, into vehicles has resulted in the development of several power lift systems. Similarly, the desire to keep the wheelchair and/or the inside of the vehicle dry and/or clean has led to the development of chair covers. However the power lift system and chair cover must be combined in a makeshift manner to provide assistance in lifting and protectively stowing wheelchairs. Moreover, current power lift systems are prohibitively expensive because they are designed to lift the wheelchair occupied by its rider. Such power lift systems also typically demand that modifications be made to the vehicle they are attached to. In other words, they are not designed for use in any vehicle. And current chair covers tend to be glorified dust covers.

As can be seen, there is a need for one apparatus or system that lifts and stows foldable wheelchairs in any vehicle.

### SUMMARY OF THE INVENTION

In one aspect of the present invention, a lifting and stowage system for objects such as foldable wheelchairs, comprises: a body sheet comprising at least one lift edge, an opening edge and a closed edge, wherein two portions of the at least one lift edge are detachably connected so that said two portions and the closed edge define a pocket within the body sheet, and wherein an opening to the pocket is formed along the open edge; a separable fastener disposed along the opening edge; a plurality of lift supports disposed along and inward from the at least one lift edge; and a lifting assembly comprising a cord operably engaging at least one pulley, wherein the cord is routed through the plurality of lift supports.

In another aspect of the present invention, a lifting and stowage system for objects such as foldable wheelchairs, comprises: a body sheet comprising at least one lift edge, an opening edge and a closed edge, wherein two portions of the at least one lift edge are detachably connected so that said two portions and the closed edge define a pocket within the body sheet, and wherein an opening to the pocket is formed along the open edge; a separable fastener disposed along the opening edge; a plurality of lift supports disposed along and inward from the at least one lift edge; at least one handle disposed along the closed edge, wherein each handle is disposed generally in opposition to each lift support; and a lifting assembly comprising a cord operably engaging at least one pulley, wherein the cord is routed through the plurality of lift supports, wherein at least one pulley handle is disposed along the cord, and wherein an anchor fastener is attached to each pulley.

These and other features, aspects and advantages of the present invention will become better understood with reference to the following drawings, description and claims.

### BRIEF DESCRIPTION OF THE DRAWINGS

FIG. 1 is a front elevation view of an exemplary embodiment of the present invention;

FIG. 2 is an exploded perspective view of an exemplary embodiment of the present invention;

FIG. 3 is a perspective view of an exemplary embodiment of the present invention;

FIG. 4 is a side elevation view of an exemplary embodiment of the present invention, shown in use; and

FIG. 5 is a second side elevation view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a lift assist for lifting at least one object to and from any suitably-sized container for stowage, transportation or usage. Say the object is a foldable wheelchair. The lift assist may include a water-proof body sheet folded to form a pocket for receiving the folded wheelchair. The pocket may be detachably closed to protectively cover the wheelchair so as not the damage or otherwise expose it to the container or vise versa. The list assist includes a lift assembly which operably engages a plurality of lift supports disposed along and inward from at least one lift edge of the body sheet. The lift assembly may include a pulley and cord and attachments for removably attaching near the container so that a user may manipulate the cord to pull and lift the protected wheelchair into the container.

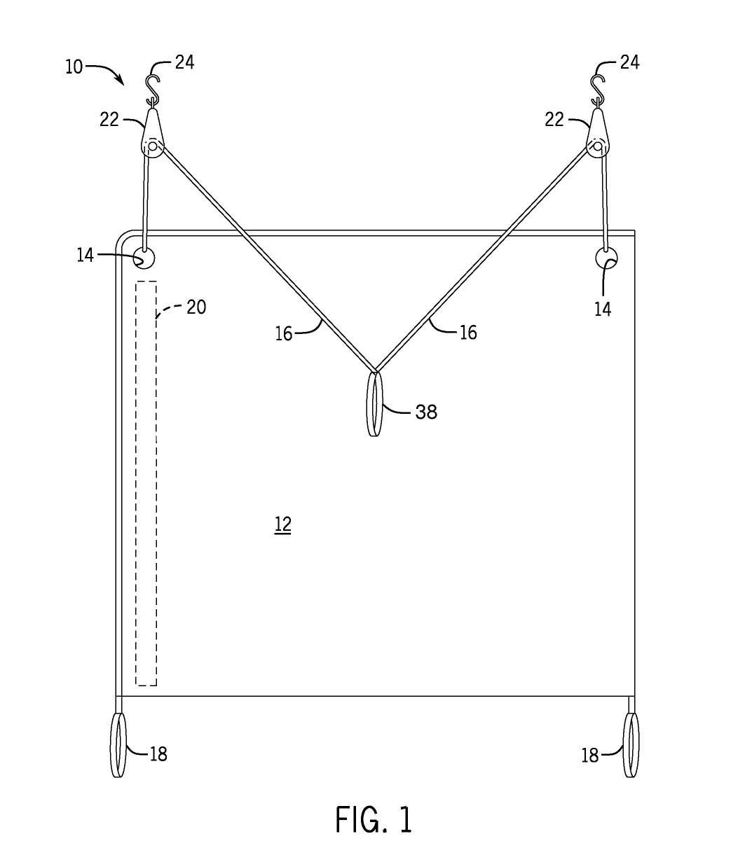

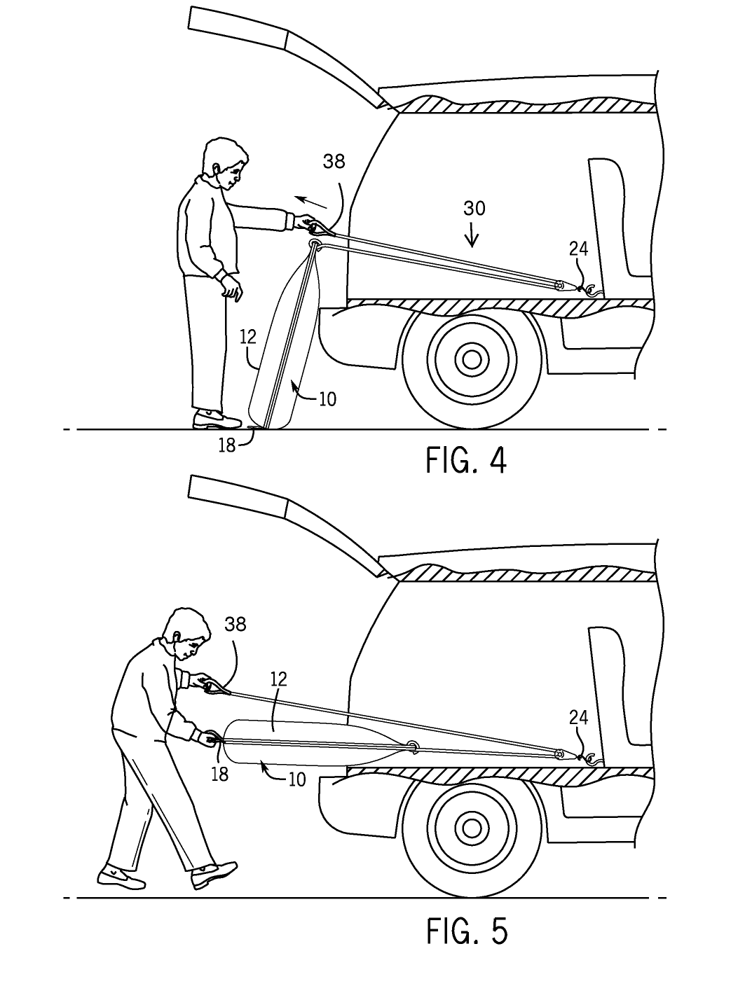

Referring to FIGS. 1 through 5, the present invention may include a lift assist 10 for lifting at least one object 26 to and from any suitably-sized container for stowage, transportation or usage. The container may be the storage space in any suitably-sized vehicle, as illustrated in FIGS. 4 and 5. The at least one object 26 may include, but not be limited to, foldable wheelchairs. The lift assist 10 may include a separable housing and a lifting assembly 30.

The separable housing may be formed from a body sheet 12 of water proof material that can be repeatedly flexed without fracturing, such as vinyl, nylon, rubber, leather, various plasticized materials and the like. The separable housing may be of sufficient size to envelope the at least one object 26, preferably into a suitcase-proportioned configuration. The body sheet 12 may be generally rectangular; though, in certain embodiments, the body sheet 12 may be substantially square, triangular or other geometric shape so long as the body sheet 12 functions in accordance with the present invention as described herein. The body sheet 12 may comprise at least one lift edge 32, an opening edge 34 and a closed edge 36. The generally rectangular body sheet 12 may be folded in roughly half so as to be connected along a portion of the closed edge 36 and connected along a portion of the at least one lift edge 32, forming a pocket within the body sheet 12, and wherein an opening to the pocket is formed along the opening edge 34. In an alternative embodiment, the portion of the at least one lift edge 32 may be releasably connected when operably engaged by the lifting assembly 30.

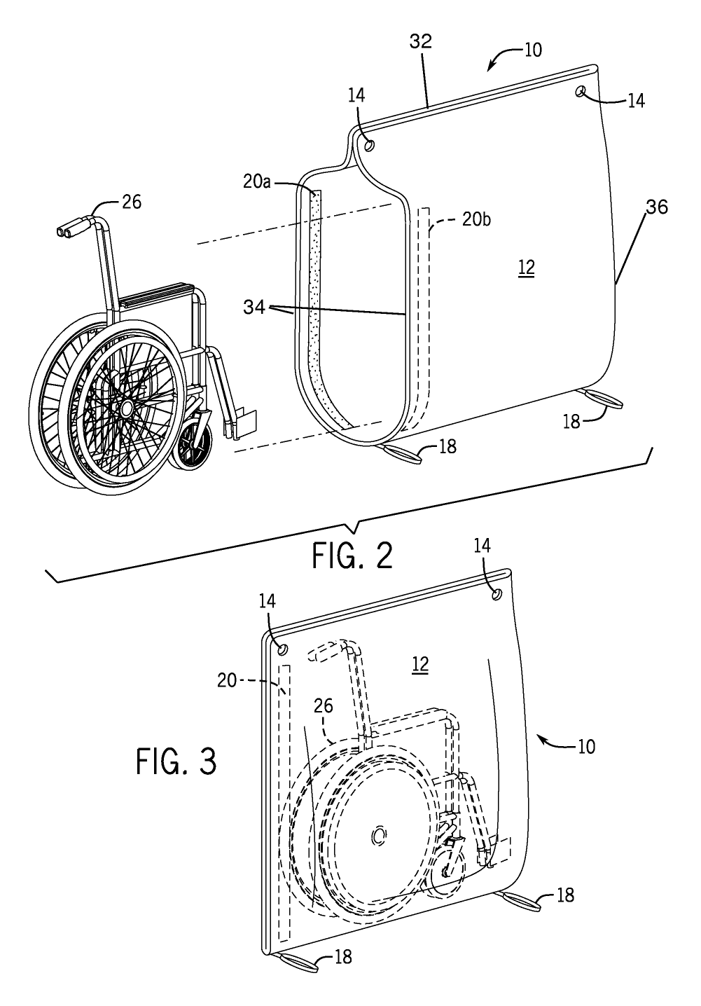

The body sheet 12 may provide a plurality of lift supports 14, including but not limited to openings reinforced with grommets. The plurality of lift supports 14 may be disposed along and inward from the at least one lifting edge 32. The separable housing may provide a plurality of handles 18 disposed along the closed edge 36 so as, in a preferred embodiment, to be on a generally opposing side of the separable housing relative to the plurality of lift supports 14, or in other words, “in opposition.” The body sheet 12 may provide a separable fastener 20 along a portion or portions of the opening edge 34, as illustrated in FIG. 2. It should be understood that the separable fastener 20 may be any fastener known in the art for fastening or removably securing one object to another so as to close the pocket, including, for example, standard push-button snaps, Velcro-type fasteners, adhesive substances, zippers, combinations thereof, and the like. It should also be that the separable fastener 20 may be configured in any array and/or number, so long as the fastener functions in accordance with the present invention as described herein.

The lifting assembly 30 may include a pulley system having a pulley cord 16 operably engaging at least one pulley 22. Each pulley 22 may provide an anchor fastener 24, such as an ‘S’ hook, or any other means for removably securing each pulley 22 to a supporting point. The cord 16 may engage the plurality of lift supports 14. The cord 16 may provide a pulley handle 38 between adjacent pulleys 22.

A method of using the present invention is as follows. The lift assist 10 disclosed above may be provided. A user may removably secure at least one anchor fastener 24 to an adjacent supporting point to establish a suitable weight distribution of the lift assist 10. Typically, the supporting points are disposed along the periphery of a stow area where the lift assist 10 is stowed. For example, in a vehicle, the supporting points may be existing hard point in the vehicle, such as the seat back or base in the trunk or the grab handle and seat base behind front seat, as illustrated in FIGS. 4 and 5. The cord 16 can be routed across different portions of the lift assist 10 for flat use than standing use. The user may first load the object 26 (folded wheelchair) into the lift assist 10 pocket through the opening, as illustrated in FIG. 2. Then the user may fasten the separable fastener 20 so as to securely encase the object 26 therein. The user may then grab the pulley handle 38 and draw the cord 16 and pull and lift the lift assist 10 into the vehicle, as illustrated in FIGS. 4 and 5.

It should be noted that the object 26 could be any heavy and or bulky object that a person, especially an elderly or physically limited person, found challenging to load into the stow area.

It should be understood, of course, that the foregoing relates to exemplary embodiments of the invention and that modifications may be made without departing from the spirit and scope of the invention as set forth in the following claims.

What is claimed is:

1. A lifting and stowage system for objects such as foldable wheelchairs, comprising:
a body sheet comprising at least one lift edge, an opening edge and a closed edge, wherein two portions of the at least one lift edge are detachably connected so that said two portions and the closed edge define a pocket within the body sheet, and wherein an opening to the pocket is formed along the open edge;
a separable fastener disposed along the opening edge;
a plurality of lift supports disposed along and inward from the at least one lift edge; and
a lifting assembly comprising a cord operably engaging at least one pulley, wherein the cord is routed through the plurality of lift supports.

2. The lifting and stowage system of claim 1, further providing at least one handle disposed along the closed edge.

3. The lifting and stowage system of claim 2, wherein each handle is disposed generally in opposition to each lift support.

4. The lifting and stowage system of claim 1, further providing at least one pulley handle disposed along the cord.

5. The lifting and stowage system of claim 1, further providing an anchor fastener attached to each pulley.

6. A lifting and stowage system for objects such as foldable wheelchairs, comprising:
a body sheet comprising at least one lift edge, an opening edge and a closed edge, wherein two portions of the at least one lift edge are detachably connected so that said two portions and the closed edge define a pocket within the body sheet, and wherein an opening to the pocket is formed along the open edge;
a separable fastener disposed along the opening edge;
a plurality of lift supports disposed along and inward from the at least one lift edge;
at least one handle disposed along the closed edge, wherein each handle is disposed generally in opposition to each lift support; and
a lifting assembly comprising a cord operably engaging at least one pulley, wherein the cord is routed through the plurality of lift supports, wherein at least one pulley handle is disposed along the cord, and wherein an anchor fastener is attached to each pulley.

7. A method of loading a foldable wheelchair into a stow area, comprising the steps of:
providing a lifting and stowage system comprising: a body sheet comprising at least one lift edge, an opening edge and a closed edge, wherein two portions of the at least one lift edge are detachably connected so that said two portions and the closed edge define a pocket within the body sheet, and wherein an opening to the pocket is formed along the open edge; a separable fastener disposed along the opening edge; a plurality of lift supports disposed along and inward from the at least one lift edge; at least one handle disposed along the closed edge, wherein each handle is disposed generally in opposition to each lift support; and a lifting assembly comprising a cord operably engaging at least one pulley, wherein the cord is routed through the plurality of lift supports, wherein at least one pulley handle is disposed along the cord, and wherein an anchor fastener is attached to each pulley;
receiving the foldable wheelchair within the pocket;
securing the separable fastener;
removably attaching at least one anchor fastener to a supporting point near the stow area; and
pulling on the pulley handle so as to draw the cord and pull and lift the body sheet into the stow area.
